(19) United States
(12) Patent Application Publication
(10) Pub. No.: US 2025/0164341 A1
(43) Pub. Date: May 22, 2025

(54) POSITIVE CONTROL SYSTEM AND METHOD FOR VALIDATING POSITIVE CONTROL OF CONTAINER CLOSURE INTEGRITY TESTING

(71) Applicant: F. HOFFMANN-LA ROCHE AG, Basel (CH)

(72) Inventor: Christian PROFF, Basel (CH)

(21) Appl. No.: 19/035,423

(22) Filed: Jan. 23, 2025

Related U.S. Application Data
(63) Continuation of application No. PCT/EP2023/075051, filed on Sep. 12, 2023.

(30) Foreign Application Priority Data
Sep. 13, 2022 (EP) 22195264.1

(51) Int. Cl. G01M 3/22; G01M 3/20

(52) U.S. Cl. CPC G01M 3/226; G01M 3/207

(57) ABSTRACT

The present invention is Claim a positive control system (1) for container closure integrity (CCI) testing comprising a container and an adapter. The container (3) has a hollow interior (31), an opening (35) and an edge (331) surrounding the opening (35). The adapter (2) has a first coupling structure (21) configured to be connected to a flow reduction holder (4), and a second coupling structure (22). The second coupling structure (22) of the adapter (2) is vacuum tightly glued to the edge (331) of the container (3). The adapter (2) is configured such that the interior (31) of the container (3) is accessible from the first coupling structure (21).

### TECHNICAL FIELD

The present invention relates to a positive control system for container closure integrity (CCI) testing and a method for validating a respective CCI testing method.

### BACKGROUND ART

Positive control generally relates to controlling the integrity of containers or packages having an intentional or known leak. Positive controls are used for a better understanding of the measurement system. In contrast, negative control relates to controlling integrity of containers or packages having no known leak, i.e. such containers or packages that were typically assembled using normally processed components.

The containers or packages to be controlled are usually in the form of a primary packaging such as a primary packaging of a drug or a pharmaceutical or chemical substance. Examples for such primary packaging are commonly used vials, cartridges or syringes.

The integrity of a container or package generally indicates the ability of keeping a content inside the respective container or package and of keeping detrimental environmental contaminants outside the respective container or package.

Leaks are typically perceived as holes or cracks of a certain diameter and length. The leakage is a measure of gas flow (typically in mass or volume) that passes through a leak path under specific conditions. Leakage of 1 [mbar×I/sec] is given when the pressure in a closed container of 1 liter rises or falls within 1 sec by 1 mbar.

A commonly used CCI test method is differential pressure (DP) method. This method is a pneumatic method with permanent or non-permanent leaks. It requires a headspace or liquid that vaporizes. Instant testing is possible with the DP method.

During pneumatic testing the sample typically is arranged in a sealed chamber. Then, either a vacuum or pressure is applied to the chamber. Appropriate sensors are used to monitor the pressure conditions in the chamber. If any gas exchange with the sample occurs, pressure conditions change which indicates a leak.

Other known CCI test methods include head space analysis (HSA), mass spectrometry (MS) and high voltage (HVLD).

Systems used for positive control of CCI testing typically require comparably complicated set-ups. This may include specific structures which one hand may be laborious to build, not sufficiently representing containers to be tested. Further, known positive control procedures are destructive such that the specific structures are impaired.

Therefore, there is a need for a system and/or method allowing an improved positive control of CCI testing.

### DISCLOSURE OF THE INVENTION

According to the invention this need is settled by a positive control system as it is defined by the features of independent claim 1 and by a method as it is defined by the features of independent claim 13. Preferred embodiments are subject of the dependent claims.

In one aspect, the invention is a positive control system for container closure integrity (CCI) testing which comprises a container and an adapter. The container has a hollow interior, an opening and an edge surrounding the opening. The adapter is equipped with a first coupling structure configured to be connected to a flow reduction holder, and a second coupling structure. The second coupling structure of the adapter is vacuum tightly glued to the edge of the container. The adapter is configured such that the interior of the container is accessible from the first coupling structure. Thereby, the interior of the container can particularly be in fluid connection with or be accessed by the flow reducer when being connected to the first coupling structure.

The term “integrity” of a container or package refers to the ability of keeping a content inside the respective container or package and of keeping detrimental environmental contaminants outside the respective container or package. Particularly, when the content is a drug substance or a similar pharmaceutical or chemical substance, integrity can relate to keeping the content sterile inside the container or package. Also, the content may comprise a combination of substances such as a drug substance and a gas, e.g., nitrogen. Environmental contaminants may include microorganisms, reactive gases and other substances.

The container can particularly be a pharmaceutical container, i.e., a container or primary packaging arranged to house a drug substance. Typically, pharmaceutical containers allow to keep the drug substance in a protected sterile environment.

The term “drug” as used herein relates to a therapeutically active agent, also commonly called active pharmaceutical ingredient (API), as well as to a combination of plural such therapeutically active substances. The term also encompasses diagnostic or imaging agents, like for example contrast agents (e.g. MRI contrast agents), tracers (e.g. PET tracers) and hormones, that need to be administered in liquid form to the patient.

The term “drug substance” as used herein relates to a drug as defined above formulated or reconstituted in a form that is suitable for administration to the patient. For example, besides the drug, a drug substance may additionally comprise an excipient and/or other auxiliary ingredients. A particularly preferred drug substance in the context of the invention is a drug solution, in particular a solution for oral administration, injection or infusion.

The term “drug product” relates to a finished end product comprising a drug substance or a plurality of drug substances. In particular, a drug product may be a ready to use product having the drug substance in an appropriate dosage and/or in an appropriate form for administration. For example, a drug product may include an administration device such as a prefilled syringe or the like.

The positive control system according to the invention allows for achieving a high quality and reliable CCI testing, which can particularly be a physical CCI (pCCI) testing.

For example, the positive control system allows to reuse the involved components and, particularly, the container-adapter assembly such that the exact original volume and leakage can be kept and reused. More specifically, the same leakage can be used for plural testing methods which allows for increasing quality of testing the container integrity. Advantageously, the positive control system is used in plural deterministic leak test methods in accordance with chapter 1207.2 of the United States Pharmacopeia. For example, the positive control system can be used in deterministic leak test methods being plural of a laser-based gas headspace analysis method, a mass extraction method, a pressure decay method, a tracer gas detection vacuum or sniffing mode method, and a vacuum decay method. Furthermore, the positive control system allows for preventing the need for a container dummy which, typically, increases complexity in positive control of CCI.

Preferably, the positive control system comprises a flow reduction holder configured to be tightly connected to the first coupling structure of the adapter and to accommodate a flow reducer. The flow reducer can be any structure or element suitable to reduce a gas flow to a predefined extent. For example, the flow reducer can be a blend having a through hole of a specifically dimensioned hole.

In a preferred embodiment, the flow reduction holder is a microcapillary holder. By means of such microcapillary holder a microcapillary can efficiently be held to precisely mimic a leakage of an appropriate extent. The microcapillary may also be comprised by the positive control system.

The term “microcapillary” as used herein relates to microtubes or micropipettes suitable for simulating single-orifice defects. The microcapillaries may be formed of glass or any appropriate plastic material and can have a diameter in the range of approximately 0.1 μm to approximately 500 μm or, more specifically, in the range of approximately 2 μm to approximately 9 μm. A diameter up to about 10 μm or 15 μm may be appropriate for helium leakage testing. A diameter up to about 150 μm or about 30 μm may be appropriate for vacuum decay or pressure decay testing Microcapillaries are usually employed as a substitute for smaller-bore, shorter-length leak path when performing tests that rely on gas flow measurements.

The microcapillary holder may comprise a body having an elongated portion configured to tightly connect to the first coupling structure of the adapter. The elongated portion may serve as connecting portion for a potential adapter. Thus, the elongated portion may comprise a taper at its free end to be conveniently connectable to another structure. The elongated portion of the body may taper towards a longitudinal end to efficiently facilitate an efficient coupling with the adapter.

The elongated portion or the body may have an outer diameter in a range of about 4 mm to about 9 mm, or in a range of about 5.5 mm to about 7.5 mm, or in a range of about 6 mm to about 7 mm. Such an elongated portion can be beneficial in many applications and/or for an efficient handling of the fixed microcapillary.

Thereby, the body of the microcapillary holder preferably comprises a lateral circumference and a duct, wherein the duct of the body extends through the elongated portion, and wherein the duct of the body is dimensioned to receive the microcapillary.

The term “lateral circumference” in connection with the microcapillary holder can relate to an outer boundary of the body transverse to the longitudinal axis. It may also include a section of the body with an enlarged diameter, i.e. compared to the elongated portion.

The duct may be embodied in the form of a straight bore configured to precisely enclose the respective microcapillary in order not to allow any gas stream between the outer wall of the microcapillary and the inner surface of the duct. The duct may enclose the microcapillary over substantially its entire length. Usually, only one end of the microcapillary slightly protrudes in to a cavity of the head portion of the holder.

By the duct being dimensioned to hold the microcapillary when the microcapillary is received, it can be ensured that the microcapillary has a firm seat. It can be prevented that the microcapillary breaks or gets damaged during use.

The duct may have an inner diameter in a range of about 0.5 mm to about 3 mm, or in a range of about 1 mm to about 2 mm, or of about 1.5 mm. Such dimensions of the duct allow for efficiently and safely holding and positioning microcapillaries widely used in CCI testing.

Further, the duct can have a length in range of about 0.5 cm to about 5 cm, or in a arrange of about 1.5 cm to about 3.5 cm, or in a range of about 2 cm to about 3 cm. Such duct allows for securely holding the microcapillary over a substantial length. Like this a safe holding can be achieved.

The body of the microcapillary holder preferably comprises a pass-through channel extending between the lateral circumference and the duct. Such pass-through channel of the microcapillary holder allows to apply or provide an adhesive to the microcapillary into the duct such that the microcapillary is tightly fixed in the duct. Like this, the microcapillary can be securely and efficiently handled in CCI or pCCI testing such that more reliable results can be achieved.

The pass-through channel of the body of the microcapillary holder preferably opens at the lateral circumference and at the duct. Like this the pass-through channel is conveniently accessible such that an adhesive can efficiently be provided to tightly fix the microcapillary positioned in the duct.

The pass-through channel of the body of the microcapillary holder preferably is essentially orthogonal to the longitudinal axis of the elongated portion of the body of the microcapillary holder. This orientation is particularly advantageous for applying adhesive substances in an efficient manner.

The pass-through channel of the body may have an inner diameter in a range of about 0.5 mm to about 3 mm, or in a range of about 1 mm to about 2 mm, or of about 1.5 mm. Such dimensions allow for efficient provision of adhesive through the pass-through to the microcapillary arranged in the duct.

The above dimensions of the elongated portion, the duct and/or the pass-through channel, particularly in sum, have proven to be particularly beneficial for commonly used microcapillaries for (p)CCI testing.

The body of the microcapillary holder preferably comprises a head portion from which the elongated portion extends. Thereby, the head portion preferably has a cavity to which the duct opens. The cavity may be provided for receiving a filter unit. Like this, the cavity can encase, support and protect the filter unit.

The cavity preferably transitions into the duct via a tapering section. In this manner a sophisticate insertion of the microcapillary into the duct can be achieved. In particular, the risk of damaging the microcapillary when being introduced into the duct can be lowered. Furthermore, a gas flow may be improved.

Preferably, the microcapillary holder comprises a nut with a first mounting structure, wherein the head portion of the body of the microcapillary holder has a second mounting structure corresponding to the first mounting structure of the nut such that the nut is mountable to the head of the body by the first mounting structure and the second mounting structure interacting. Thereby, the first and second mounting structures can be embodied as threads, or bayonet closures or the like. In this manner a particularly tight and releasable mounting of a filter unit is possible.

Preferably, the microcapillary holder comprises a filter unit arranged in the cavity of the head portion of the body such that the duct is covered, wherein the filter unit preferably is locked in the cavity of the head portion of the body by the nut. This ensures that the gas flows through the filter such that, e.g., contaminations can be kept off the microcapillary.

The filter unit may be locked in the cavity of the head portion of the body by the nut. In this manner the tight and releasable fit may be further improved.

A first gasket can be arranged between the filter unit and the head portion of the body. Advantageously, the first gasket is an O-ring. Further, a second gasket can be arranged between the filter unit and the nut. Advantageously, the second gasket is an O-ring. The O-rings have proven to provide particularly reliable and tight sealing.

It is noted that the positive control system with the nut may also be applied for permeability measurements. In this case, the dimensions of the microcapillary holder and of the nut may be different from the dimensions used when carrying out CCI tests. In particular, the duct may be somewhat bigger or smaller. Also, in such a case, no pass-through channel for the adhesive would be required, particularly, if no microcapillary is used for flow reduction.

Preferably, the adapter has a sealing arrangement configured to seal the connection between the first coupling structure and the flow reduction holder. Thereby, the sealing arrangement of the adapter preferably comprises at least one O-ring. Also, the first coupling structure of the adapter preferably comprises at least one circumferential recess configured to accommodate the at least one O-ring.

Preferably, the positive control system comprises a microcapillary adhesive configured to be delivered into the pass-through channel of the body of the microcapillary holder when the microcapillary is received in the duct of the body of the microcapillary holder such that the microcapillary is fixed in the duct of the microcapillary holder.

Preferably, the second coupling structure of the adapter is vacuum tightly glued to the edge of the container by means of a vial adhesive. The vial adhesive and the microcapillary adhesive may be the same. For example, an epoxy adhesive may be a suitable adhesive for both.

Preferably, the adapter is made of a metal and, preferably, a stainless steel. Such metal adapter allows for providing sufficient robustness and sterility.

As described above, the container can be a receptacle for a drug substance, particularly being a liquid drug substance. For example, the container may be a syringe such as staked-in needle (SIN) or other prefilled syringe (PFS), a cartridge or a vial.

The term “vial” as used herein can relate to vials in the literal sense, i.e. a comparably small vessel or bottle, often used to store pharmaceutical products or pharmaceuticals or medications in liquid, powdered or capsuled form. The vial can be made of a sterilisable material such as glass or plastic such as, e.g., cyclic olefin polymer (COP) or polypropylene. It typically comprises a cover or cap including a sealing such as a rubber stopper or a septum which for many applications is designed to be pierced.

In particular, the container preferably is a vial having a head with the edge and the opening extending from the edge of the head to the interior of the vial. The vial can have a neck and a body wherein the opening including the edge is located at the head and opens the interior of the body through the neck and head. The adapter is then configured to be connected to the edge of the head of the vial. In advantageous embodiments, the head has a typical diameter such as a diameter of 13 mm or of 20 mm.

Specifically, the vial preferably is made of a light transparent material such as glass. By means of such a vial, the interior of the vial can be observed when the vial is processed. For example, optical inspection can be applied.

Preferably, the second coupling structure of the adapter comprises a circumferential recess configured to embrace the edge of the head of the vial. The recess can be formed by a circumferential groove or notch provided into a longitudinal or axial end of the adapter. Like this, a safe and sound connection between adapter and container can be established.

In another aspect, the invention is a method of positive controlling a container closure integrity (CCI) testing. The method comprises the steps of: obtaining a positive control system as described above; providing a tracer gas into the interior of the container of the positive control system; tightly connecting the first coupling structure of the adapter of the positive control system to a flow reduction holder; and applying a deterministic leak test method to positive control physical container closure integrity of the container of the positive control system having the tracer gas in its interior and the flow reduction holder tightly connected to the first coupling structure of the adapter.

The method according to the invention and its preferred embodiments described below allow to achieve the effects and benefits described above in connection with the positive control system according to the invention and its preferred embodiments. In particular, the method according to the invention allows for an improved positive control and a reliable validation of a CCI testing.

Preferably, the deterministic leak test method is a method in accordance with chapter 1207.2 of the United States Pharmacopeia. Such methods allow for providing an acknowledged positive control such that it can be used for validating the CCI testing to achieve official acceptance of it.

Preferably, the deterministic leak test method comprises at least two of a laser-based gas headspace analysis method, a mass extraction method, a pressure decay method, a tracer gas detection vacuum mode method, and a vacuum decay method. Such combination of acknowledged test methods allows for achieving a particularly high quality and reliability of the CCI testing. Moreover, the method allows to re-use the same single container-adapter assembly which may help to improve the test parameters by controlling the variables in a way not possible before by ruling out certain phenomena associated to part-to-part variation.

Preferably, the method further comprises the steps of: obtaining a microcapillary, wherein the flow reduction holder is a microcapillary holder; arranging the microcapillary into a duct of a body of the microcapillary holder; and delivering a microcapillary adhesive into a pass-through channel of the body of the microcapillary holder.

### BRIEF DESCRIPTION OF THE DRAWINGS

The positive control system according to the invention and the method according to the invention are described in more detail herein below by way of exemplary embodiments and with reference to the attached drawings, in which:

FIG. 1 shows a cross-sectional view of an adapter of a first embodiment of a positive control system according to the invention;

FIG. 2 shows a partially cross-sectional and partially side view of a portion of a vial of the positive control system of FIG. 1;

FIG. 3 shows a cross-sectional view of the positive control system of FIG. 1;

FIG. 4 shows a cross-sectional view of an adapter of a second embodiment of a positive control system according to the invention; and

FIG. 5 shows a cross-sectional view of the positive control system of FIG. 4.

### DESCRIPTION OF EMBODIMENTS

In the following description certain terms are used for reasons of convenience and are not intended to limit the invention. The terms “right”, “left”, “up”, “down”, “under” and “above” refer to directions in the figures. The terminology comprises the explicitly mentioned terms as well as their derivations and terms with a similar meaning. Also, spatially relative terms, such as “beneath”, “below”, “lower”, “above”, “upper”, “proximal”, “distal”, and the like, may be used to describe one element's or feature's relationship to another element or feature as illustrated in the figures. These spatially relative terms are intended to encompass different positions and orientations of the devices in use or operation in addition to the position and orientation shown in the figures. For example, if a device in the figures is turned over, elements described as “below” or “beneath” other elements or features would then be “above” or “over” the other elements or features. Thus, the exemplary term “below” can encompass both positions and orientations of above and below. The devices may be otherwise oriented (rotated 90 degrees or at other orientations), and the spatially relative descriptors used herein interpreted accordingly. Likewise, descriptions of movement along and around various axes include various special device positions and orientations.

To avoid repetition in the figures and the descriptions of the various aspects and illustrative embodiments, it should be understood that many features are common to many aspects and embodiments. Omission of an aspect from a description or figure does not imply that the aspect is missing from embodiments that incorporate that aspect. Instead, the aspect may have been omitted for clarity and to avoid prolix description. In this context, the following applies to the rest of this description: If, in order to clarify the drawings, a figure contains reference signs which are not explained in the directly associated part of the description, then it is referred to previous or following description sections. Further, for reason of lucidity, if in a drawing not all features of a part are provided with reference signs it is referred to other drawings showing the same part. Like numbers in two or more figures represent the same or similar elements.

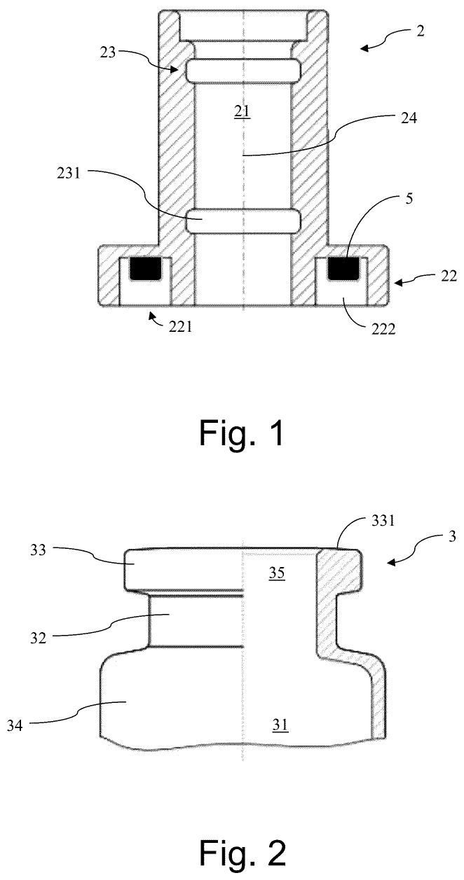

FIG. 1 shows an adapter 2 of a first embodiment of a positive control system 1 according to the invention. The adapter 2 has a generally elongated shape and rotation symmetrically extends along a longitudinal axis 24. It has an axial bore which towards an upward or proximal end forms a first coupling structure 21. The first coupling structure 21 is equipped with two axially spaced circumferential recesses 231 of a sealing arrangement 23.

Towards a bottom or distal end, the adapter 2 has a flange-like portion establishing a second coupling structure 22. The second coupling structure 22 has a circumferential notch 221 with a recess 222 open to the bottom or distal end of the adapter 2. Inside the recess 222 a vial adhesive 5 is arranged.

The adapter 2 is made of stainless steel.

In FIG. 2 a vial 3 of the positive control system 1 is shown, wherein a right half is illustrated in cross-section. The vial 3 is a 20 mm glass vial. It has a body 34 with a hollow interior 31, a head 33 and a neck 32 between the body 34 and the head 33. The neck 32 and the head 33 have an opening 35 through which the interior 31 of the body 34 is accessible. The opening 35 upwardly opens and is delimited by a circumferential edge 331 surrounding the opening 35.

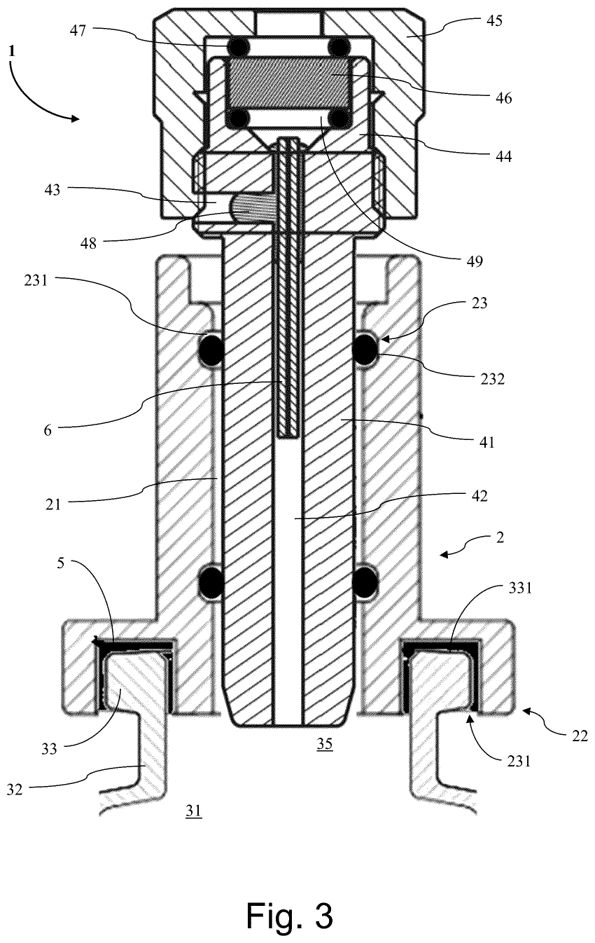

FIG. 3 shows the positive control system 1 an assembled state. The adapter 2 is set top down onto the vial 3. Thereby, the edge 331 and the complete head 33 of the vial 3 are accommodated in the recess 222 of the second coupling structure 22. The vial adhesive 5 is spread around the head 33 such that the second coupling structure 22 is vacuum tightly glued to the edge 331 of the vial 33.

The first coupling structure 21 of the adapter receives a microcapillary holder 4 as flow reduction holder. The microcapillary holder 4 comprises an elongated portion 41 which is introduced into the first coupling structure 21 of the adapter 2. The sealing arrangement 23 has two O-rings 232 each accommodated in one of the recesses 231. The O-rings 232 are squeezed between a lateral circumference of the elongated portion 41 of the microcapillary holder 4 and the inner boundary of the first coupling structure 21 of the adapter such 2 such that the microcapillary holder 4 is tightly connected to the first coupling structure 21 of the adapter 2.

The microcapillary holder 4 further comprises a head portion 44 located above the adapter 2, from which the elongated portion 41 downwardly extends into the first coupling structure 21 of the adapter 2. A duct 42 vertically passes through the microcapillary holder 4 and a pass-through channel 43 extends between the lateral circumference of the microcapillary holder 4 and the duct 41. More specifically, the pass-through channel 43 opens at the lateral circumference and at the duct 41 and is essentially orthogonal to a longitudinal axis of the elongated portion 41.

The head portion 44 of the microcapillary holder 4 has a cavity 49 to which the duct 41 opens. More specifically, the cavity 49 transitions into the duct 41 via a tapering section.

The microcapillary holder 4 further has a nut 45, a filter unit 46 and two O-rings 47. The filter unit 46 is arranged in the cavity 49 on top of one of the O-rings 47. The nut 45 has an inner thread as first mounting structure and is screwed onto the head portion 44, which is equipped with a corresponding outer thread as second mounting structure, such that the cavity 49 is closed. Between the nut 45 and the filter unit 46 the second of the two O-rings is arranged. By fastening the nut 45 on the head portion 44, the filter unit 46 is clamped between the two O-rings 47 such that it is locked and tightened.

The microcapillary holder 4 receives a microcapillary 6. In particular, the microcapillary 6 is inserted top down into the duct 42. A microcapillary adhesive 48 is provided through the pass-through channel 43 into the duct 41 such that the microcapillary is vacuum-tightly fixed in the microcapillary holder 4.

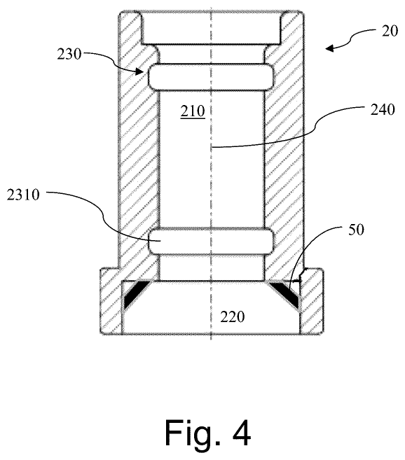

In FIG. 4 an adapter 20 of a second embodiment of a positive control system 10 according to the invention is shown. The adapter 20 is similarly embodied as the adapter 1 shown in FIGS. 1 to 3 but is designed to be glued on a vial 30 of smaller dimensions, i.e. a 13 mm vial. The adapter 20 has a generally elongated shape and rotation symmetrically extends along a longitudinal axis 240. It has an axial bore which towards an upward or proximal end forms a first coupling structure 210. The first coupling structure 210 is equipped with two axially spaced circumferential recesses 2310 of a sealing arrangement 230.

Towards a bottom or distal end, the adapter 20 has a flange-like portion establishing a second coupling structure 220. In particular, by the flange-like portion a step is formed in the interior of the adapter 20. On this step a vial adhesive 50 is arranged.

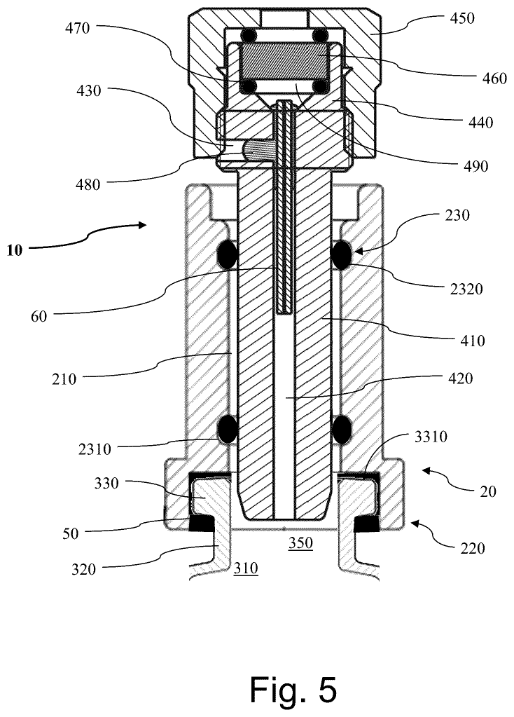

FIG. 5 shows the second positive control system 10, wherein-aside from its dimensions-it is similarly designed as the first positive control system 1 of FIGS. 1 to 3. In particular, other than the adapter 20, the positive control system 10 comprises structurally identical elements than the positive control system 1. More specifically, the positive control system has a microcapillary holder 40 comprising a head portion 440 with a cavity 490, an elongated portion 410, a duct 420 receiving a microcapillary 60, a pass-through channel 430, a nut 450, a filter unit 460 two O-rings 470 and a microcapillary adhesive 480, as well as the vial 30 having a body 340 with a hollow interior 310, a head 330, a neck 320 and an opening 350 with a circumferential edge 3310.

As can be seen in FIG. 5, for being vacuum tightly glued to the vial, the adapter 20 is arranged onto the vial 30 such that the head 330 of the vial 30 is received in the second coupling structure 220. Thereby, the vial adhesive 50 spreads around the head 330 of the vial 30 and locks the vial 30 to the adapter 20.

This description and the accompanying drawings that illustrate aspects and embodiments of the present invention should not be taken as limiting-the claims defining the protected invention. In other words, while the invention has been illustrated and described in detail in the drawings and foregoing description, such illustration and description are to be considered illustrative or exemplary and not restrictive. Various mechanical, compositional, structural, electrical, and operational changes may be made without departing from the spirit and scope of this description and the claims. In some instances, well-known circuits, structures and techniques have not been shown in detail in order not to obscure the invention. Thus, it will be understood that changes and modifications may be made by those of ordinary skill within the scope and spirit of the following claims.

The disclosure also covers all further features shown in the Figs. individually although they may not have been described in the afore or following description. Also, single alternatives of the embodiments described in the figures and the description and single alternatives of features thereof can be disclaimed from the subject matter of the invention or from disclosed subject matter. The disclosure comprises subject matter consisting of the features defined in the claims or the exemplary embodiments as well as subject matter comprising said features.

Furthermore, in the claims the word “comprising” does not exclude other elements or steps, and the indefinite article “a” or “an” does not exclude a plurality. A single unit or step may fulfil the functions of several features recited in the claims. The mere fact that certain measures are recited in mutually different dependent claims does not indicate that a combination of these measures cannot be used to advantage. The terms “essentially”, “about”, “approximately” and the like in connection with an attribute or a value particularly also define exactly the attribute or exactly the value, respectively. The term “about” in the context of a given numerate value or range refers to a value or range that is, e.g., within 20%, within 10%, within 5%, or within 2% of the given value or range. Components described as coupled or connected may be electrically or mechanically directly coupled, or they may be indirectly coupled via one or more intermediate components. Any reference signs in the claims should not be construed as limiting the scope.

1. A positive control system for container closure integrity testing, comprising
a container having a hollow interior, an opening and an edge surrounding the opening; and
an adapter with a first coupling structure configured to be connected to a flow reduction holder, and a second coupling structure,
wherein the second coupling structure of the adapter is vacuum tightly glued to the edge of the container, and
wherein the adapter is configured such that the interior of the container is accessible from the first coupling structure.

2. The positive control system of claim 1, comprising a flow reduction holder configured to be tightly connected to the first coupling structure of the adapter and to accommodate a flow reducer.

3. The positive control system of claim 2, wherein the flow reduction holder is a microcapillary holder.

4. The positive control system of claim 2, wherein the adapter has a sealing arrangement configured to seal the connection between the first coupling structure and the flow reduction holder.

5. The positive control system of claim 4, wherein the sealing arrangement of the adapter comprises at least one O-ring.

6. The positive control system of claim 5, wherein the first coupling structure of the adapter comprises at least one circumferential recess configured to accommodate the at least one O-ring.

7. The positive control system of claim 1, wherein the second coupling structure of the adapter is vacuum tightly glued to the edge of the container by means of a vial adhesive.

8. The positive control system of claim 1, wherein the adapter is made of a metal.

9. The positive control system of claim 8, wherein the adapter is made of a stainless steel.

10. The positive control system of claim 1, wherein the container is a vial having a head with the edge and the opening extending from the edge of the head to the interior of the vial.

11. The positive control system of claim 10, wherein the vial is made of a light transparent material such as glass.

12. The positive control system of claim 1, wherein the second coupling structure of the adapter comprises a circumferential recess configured to embrace the edge of the head of the vial.

13. A method of positive controlling a container closure integrity testing, comprising:
obtaining a positive control system of claim 1, providing a tracer gas into the interior of the container of the positive control system,
tightly connecting the first coupling structure of the adapter of the positive control system to a flow reduction holder, and
applying a deterministic leak test method to positive control physical container closure integrity of the container of the positive control system having the tracer gas in its interior and the flow reduction holder tightly connected to the first coupling structure of the adapter.

14. The method of claim 13, wherein the deterministic leak test method is a method in accordance with chapter 1207.2 of the United States Pharmacopeia.

15. The method of claim 13, wherein the deterministic leak test method comprises at least two of a laser-based gas headspace analysis method, a mass extraction method, a pressure decay method, a tracer gas detection vacuum mode method, and a vacuum decay method.

16. The method of claim 13, comprising:
obtaining a microcapillary, wherein the flow reduction holder is a microcapillary holder,
arranging the microcapillary into a duct of a body of the microcapillary holder, and
delivering a microcapillary adhesive into a pass-through channel of the body of the microcapillary holder.
